(19) United States
(12) Patent Application Publication
(10) Pub. No.: US 2010/0194778 A1
(43) Pub. Date: Aug. 5, 2010

(54) PROJECTING DATA DIMENSIONS ON A VISUALIZATION DATA SET

(75) Inventors: George G. Robertson, Seattle, WA (US); Christian Bernd Schormann, Seattle, WA (US); Ahmed K. Kamal, Bellevue, WA (US); Morten Holm-Peterson, Gentofte (DK); Brian Scott Ruble, Bellevue, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/362,550

(22) Filed: Jan. 30, 2009

(51) Int. Cl. G09G 5/00; G06T 15/70

(52) U.S. Cl. 345/619; 345/473; 345/156

(57) ABSTRACT

A visualization system is provided. The system includes a visualization component that displays at least two dimensions of data in at least a two dimensional view of the data. A selection component indicates at least one other dimension of data and a projection component expands the two dimensional view of the data with at least one other dimensional view of the data.

### BACKGROUND

Data visualization refers to the visual representation of data, defined as information which has been abstracted in some schematic form, including attributes or variables for the units of information. With the rapid increase of computing power, larger and more complex numerical models for visualization have been developed, resulting in the generation of huge numerical data sets. Also, large data sets were generated by data acquisition devices such as medical scanners and microscopes, where data has been collected in large databases containing text, numerical information, and multimedia information. Thus, advanced computer graphics techniques were needed to process and visualize such data sets.

Visualization is often considered a part of a process of scientific computing that includes the use of computer modeling and simulation in scientific and engineering practice. More recently, visualization has increasingly been concerned with data from other sources, including large and heterogeneous data collections found in business and finance, administration, digital media, and so forth. A new research area called Information Visualization was launched in the early 1990s, to support analysis of abstract and heterogeneous data sets in many application areas.

Generally, data visualization is an evolving concept where definitional boundaries are continually expanding and, as such, is best defined in terms of loose generalizations. It refers to the more technologically advanced techniques, which allow visual interpretation of data through the representation, modeling and display of solids, surfaces, properties and animations. This involves the use of graphics, image processing, computer vision, and user interfaces. Data visualization also encompasses a much broader range of techniques than specific techniques such as solid modeling, for example. The success of data visualization is due to the soundness of the basic idea behind the technology including the use of computer-generated images to gain insight and knowledge from data and its inherent patterns and relationships. A second premise is the utilization of the broad bandwidth of the human sensory system in steering and interpreting complex processes, and simulations involving data sets from diverse scientific disciplines having large collections of abstract data from many sources. These concepts are important and have a profound and widespread impact on the methodology of computational science and engineering, as well as on management and administration.

One aspect to visualization involves the use of layering in two dimensional renderings. For example, a map of the United States might be displayed as an image where sales regions or other category is overlaid on to the map for further analysis. Although useful, such rendering does little to expound upon other data relationships that may exist with the data. For instance, the underlying map is static and typically, the data placed on to the map is also presented in static form. There may be other relationships between the geography and sales data that may explain why one region is more successful than another, for example. Moreover, as data views become more complex and having multiple dimensions for example, it may not be apparent to users all the useful relationships that may be available and are otherwise hidden from view.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

Visualization systems and methods are provided to dynamically generate additional dimensional views of data in accordance with existing data sets. Rotating or pivoting action along with multiple angles of projection allow data dimensions to be projected on to lower order dimensional views of data in order to facilitate a better understanding of diverse data relationships. In one example, a two dimensional data selection may have an existing view such as columns on a bar chart. By selecting another data dimension, the column can be dynamically expanded to show at least one other dimension such as a third dimension. For example, a column on the chart may be expanded to add depth from another data set, where the depth provides additional information regarding an existing view of data. Data presentations and animations can be dynamically constructed one dimension at a time if desired to facilitate the user's understanding of complex data relationships. Also, if a particular dimension is selected for further analysis, the selected dimension can be rotated or pivoted into view and the other dimensions can be projected to other less prominent views. From the newly selected views, additional data views can accordingly be selected and projected on the display.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a schematic block diagram illustrating a visualization system that projects dimensional data on to existing data sets.

FIG. 2 is a block diagram that illustrates alternative data projection aspects.

FIG. 3 is a flow diagram that illustrates an example visualization process that projects data dimensions on to existing data projections.

FIG. 4 illustrates an example multidimensional projection.

FIG. 5 illustrates example data selection groupings from a data set.

FIG. 6 a block diagram illustrates miscellaneous visualization controls.

FIG. 7 illustrates an example system for transitioning or morphing between dynamic display visualizations.

FIG. 8 illustrates an example visualization transition.

FIG. 9 is a schematic block diagram illustrating a suitable operating environment.

FIG. 10 is a schematic block diagram of a sample-computing environment.

### DETAILED DESCRIPTION

Systems and methods enable users to generate diverse perspectives and views on data. In one aspect, a visualization system is provided. The system includes a visualization component that displays at least two dimensions of data in at least a two dimensional view of the data. A selection component indicates at least one other dimension of data and a projection component expands the two dimensional view of the data with at least one other dimensional view of the data. By projecting additional dimensions on to an existing data set, relationships and data analysis are highlighted or promoted that may not be apparent from conventional data renderings (e.g., 2d bar chart).

As used in this application, the terms “component,” “selection,” “projection,” “visualization,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

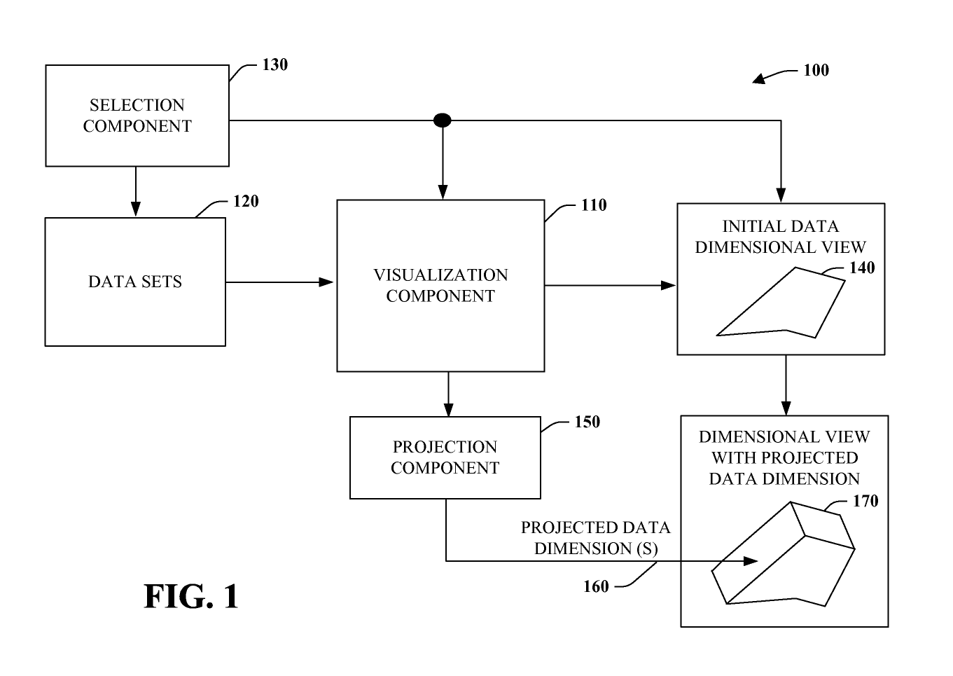

Referring initially to FIG. 1, a visualization system 100 projects dimensional data on to existing data sets. The system 100 includes a visualization component 110 that processes various data sets 120 and commands from a user via a selection component 130. Initially, at least a two dimensional view is projected at 140, where the view is constructed from the data sets 120. Based upon commands or gestures from the user, the selection component 130 can indicate to the visualization component 110 that alternative views of the data sets 120 should be provided. This can include various rotations or viewing pivots that are generated via a projection component 150, where a data dimension 160 (collected from the data sets) is projected on to the initial image 140. In this example, the image at 140 is projected into a third dimension illustrated at 170. In general, substantially any initial data projection that is enhanced/increased by at least one other dimension or more to convey information to the user is considered within the scope of the subject claims. As shown at 170, the third projected dimension 160 in this example adds depth to the initial image projected at 140.

In general, the visualization system 100 dynamically generates additional/subsequent dimensional views of the data sets 120 in accordance with existing data sets. Rotating or pivoting action along with multiple angles of projection at 170 allow data dimensions to be projected on to lower order dimensional views of data 140 in order to facilitate a better understanding of diverse data relationships. In one example, a two dimensional data selection may have an existing view such as columns on a bar chart or other two-dimensional shape such as shown at 140. By selecting another data dimension via the selection component 130, the column can be dynamically expanded to show at least one other dimension such as a third dimension. For example, a column on the chart may be expanded to add depth from another data set 120, where the depth provides additional information regarding an existing view of data. Data presentations and animations can be dynamically constructed one dimension at a time if desired to facilitate the user's understanding of complex data relationships. Also, if a particular dimension is selected for further analysis, the selected dimension can be rotated or pivoted into view and the other dimensions can be projected to other less prominent views. From the newly selected views 170, additional data views can accordingly be selected and projected on the display.

From the initial projection 140, the added dimensional shaping can be used to convey information. For example, if the initial image was a column relating to corn harvest information, the additional depth provided by the projection 160 might convey the rate at which the corn was actually consumed by the public. Thus, in addition to understanding the harvest information the user might gain an understanding of whether or not stock piles were accumulating (e.g., larger depth to indicate low rate of consumption, smaller depth to indicate that demand was greater than what was currently harvested). The selection component 130 can operate in a bidirectional manner. In one aspect, the selection component can point/gesture toward one or more elements in the data sets. Based upon that action, the visualization component 110 and the projection component 150 can embellish the initial image 140 by projecting the image 170. In another aspect, the user can gesture toward the image 140 or 170 and cause various views, rotations, or projections to occur that might highlight one or more of the data sets 120 while minimizing the display on one or more other data sets.

It is noted that visualizations can be manipulated via gestures to the selection component 130 from substantially any form including data displays, charts, graphs, animations, images, video, audio, and so forth. Gestures can include speech, hand movements, mouse actions, light pen movements, and substantially any biometric indication regarding a change to a given display or data presentation. As noted previously, gestures can be directed to the underlying data sets 120 or to the images themselves (e.g., image 140 or image 170). In another aspect, a visualization projection system is provided. The system includes means for generating (e.g., visualization component 110) a two dimensional display of data from a plurality of data sets. The system also includes means for selecting (e.g., selection component 130) a data set or gesturing to the display of data and means for projecting (e.g., projection component 150) an additional dimension of data on to the display of data, the additional dimension of data selected from the plurality of data sets.

In another aspect, animation can be employed to show where data came from or went to when transitioning between visualizations or data sets 120. Dimension transitions and dynamic data views for the respective data dimension changes can be provided. As a particular change occurs, the view moves into a three-dimensional view (or other dimension, e.g., time dimension) where other elements appear to extrude out of side of display (or other angle). In the three-dimensional view, a single bar on a pie chart can become a selective row, for example. When that bar is chosen, all the other bars drop to the bottom (or out of the display) and the view is brought back to two-dimensional. This allows the view to follow the selection, which might be scattered across whole dimensions.

In yet another aspect, it can be difficult for some users to quickly understand and interpret data presented in multiple dimensions. Thus, it may not be practical to automatically present a three-dimensional image or four-dimensional image and expect instant understanding. The system 100 allows complex analysis to be presented by layering or sequencing dimensions as the data sets or projections are perused. Data might first be presented as a two-dimensional bar chart, then a third dimension added, then a fourth dimension added, and so forth. This allows the recipient to build up the complexity themselves and the information is easier to follow and interpret. An experienced user might not need the gradual composition as they might be able to quickly analyze and identify the various dimensions. Layering of dimensions allows the analysis to be stepped. The initial view can be based on the quickness of understanding. As the data set narrows, the complexity of the views can be increased. In a related aspect, this concept can be applied to transition from a smaller data set back onto the larger data set, or onto a related set of data.

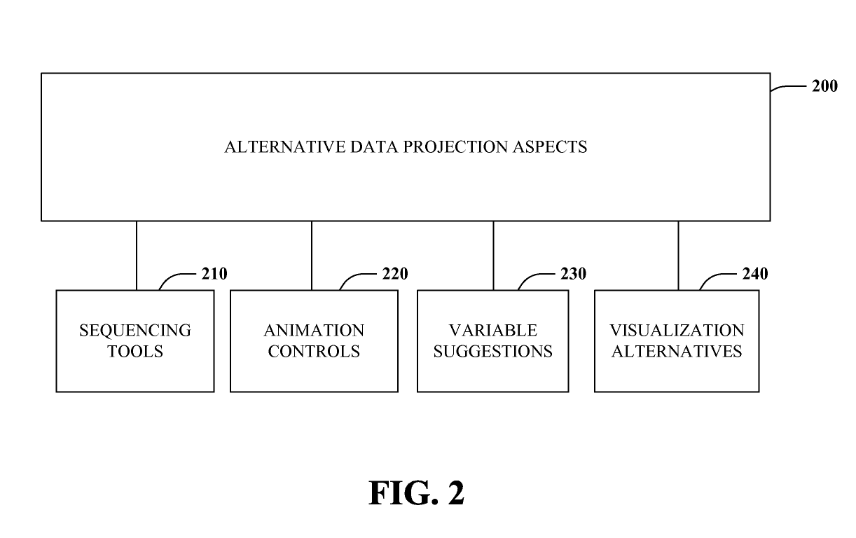

Referring now to FIG. 2, alternative data projection aspects 200 are provided that can be employed with the systems described above. At 210, various sequencing tools can be provided. This includes models that enable complex visualizations to be broken into elements. Thus, the sequencing tools 210 can lead viewers through data by breaking down into more manageable components. This also includes providing analysis history and tracking previous movements or gestures. At 220, one or more animation controls can be provided. This includes controlling the speed of animation based on complexity of data and/or projections involved. Generally, using speed of animation as a dimension of visualization. The speed of animation can be a function of the experience of the user, the complexity of the data, or both. If the information to be presented is perceived to be more complex for a user to comprehend, the animation can be slowed down so that the changes applied can be more easily understood. If there are only a few data points, the animation speed can be increased. Speed is a property itself. Viewers are generally more sensitive to acceleration and declaration rather than to a constant speed.

At 230, variable suggestions can be provided. Thus, for dimensions other than time, variables can be suggested that present suitable candidates for use in a “slider” investigation, for example. This can include employing animations to show transitions and/or trends, to highlight particular features, or animated characters (e.g., narration from an avatar). If tracking sales by country, plot increases (or decreases) in sales in another dimension. If it were illustrated simply in alphabetical order for example, it might have little value to the user.

Visualization alternatives 240 provide a range of data changes for animations. For example, certain element can be presented at high speed and quickly in order to locate the right position, and then slowly ease out because the motion parallax helps the viewer to orient to the new scene. If moving from one view to another, orient to that view quickly and then slowly ease out—motion parallax. This can also depend on whether it is two-dimensional or not. The complexity is a function of the complexity of selection or focus and not on the number of elements as the previous example. It is to be appreciated however that combinations of controls described herein can be provided.

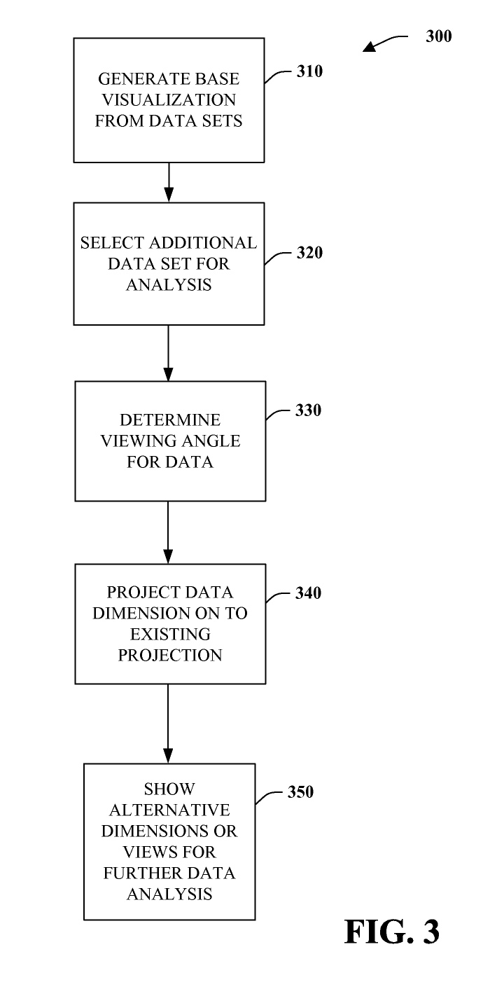

Referring now to FIG. 3, a visualization process is illustrated. While, for purposes of simplicity of explanation, the process is shown and described as a series or number of acts, it is to be understood and appreciated that the subject process is not limited by the order of acts, as some acts may, in accordance with the subject processes, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject processes described herein.

Turning to FIG. 3, an example visualization process 300 is illustrated that employs projects data dimensions on to existing projections of data. Proceeding to 310, a base visualization is generated from data sets. Typically, this involves at least two dimensions of data that are projected as a two-dimensional rendering. It is to be appreciated however that other base projections are possible (e.g., start with a 3d base and project an alternative dimension). At 320, at least one other data set is selected for rendering. The data set can be selected by user controls or can be selected automatically such as inferred from a user's query or actions when viewing a given rendering. At 330, a viewing angle is determined for projection. This can be controlled by user gestures or derived automatically such as derived from the orientation angle the user is currently viewing the visualization. At 340, the additional or alternative data set is projected on to the existing projection of data. For example, expand a 2D rendering into 3D where the additional dimension conveys information relating to the data sets that have already been projected. At 350, alternative views can be provided for further analysis.

As noted previously, complex analysis and renderings can be presented by layering or sequencing dimensions as the data sets or projections are analyzed by the user. Data might first be presented as a two-dimensional bar chart, then a third dimension added, then a fourth dimension added, and so forth. This allows the recipient to build up the complexity themselves and the information is easier to follow and interpret. An experienced user might not need the gradual composition as they might be able to quickly analyze and identify the various dimensions. Sequencing of dimensions allows the analysis to be stepped. The initial view can be based on the quickness of understanding. As the data set narrows, the complexity of the views can be increased. In a related aspect, this concept can be applied to transition from a smaller data set back onto the larger data set, or onto a related set of data.

It is noted that interfaces (not shown) can be provided to select/control user options and render data in multidimensional views or animations. This can include a Graphical User Interface (GUI) to interact with the user or other components such as any type of application that sends, retrieves, processes, and/or manipulates data, receives, displays, formats, and/or communicates data, and/or facilitates operation of the system. For example, such interfaces can also be associated with an engine, server, client, editor tool or web browser although other type applications can be utilized.

The GUI can include a display having one or more display objects (not shown) for manipulating electronic sequences including such aspects as configurable icons, buttons, sliders, input boxes, selection options, menus, tabs and so forth having multiple configurable dimensions, shapes, colors, text, data and sounds to facilitate operations with the profile and/or the device. In addition, the GUI can also include a plurality of other inputs or controls for adjusting, manipulating, and configuring one or more aspects. This can include receiving user commands from a mouse, keyboard, speech input, web site, remote web service and/or other device such as a camera or video input to affect or modify operations of the GUI.

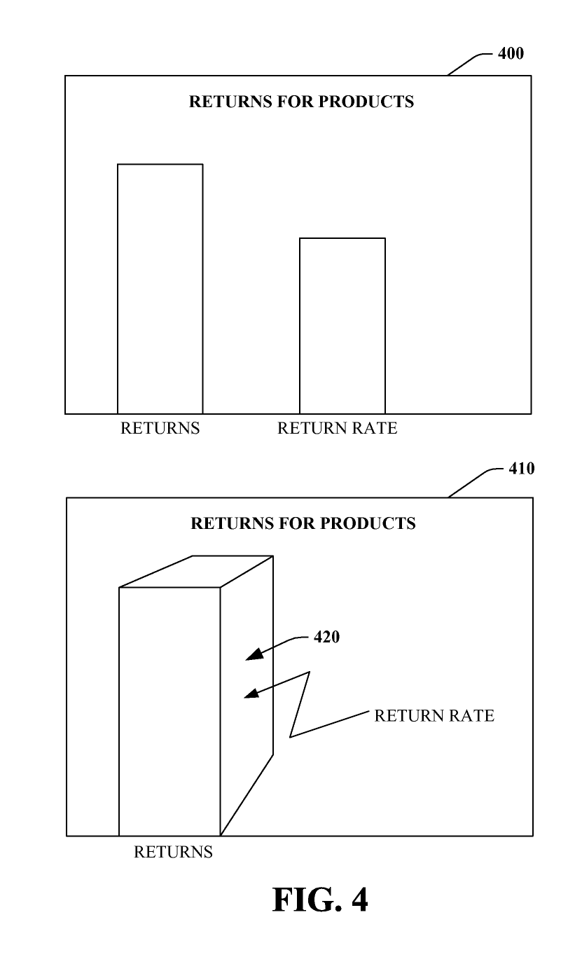

Referring now to FIG. 4, an example multidimensional projection is illustrated. An initial two dimensional render of data sets is illustrated at 400. This example shows return variables for a hypothetical product offering. As shown, one column of data in 400 represents product returns and another column of data represents return rates for the respective products. In this example, the return rate is projected on to the returns where the projection of data is illustrated in the diagram 410. As shown, an additional dimension is projected off the returns at 420 and is projected as the return rate. It is to be appreciated that the projection at 410 is but one example of projecting data dimensionally onto existing data structures. Substantially any type of data projection in a higher dimension is within the scope of the subject claims.

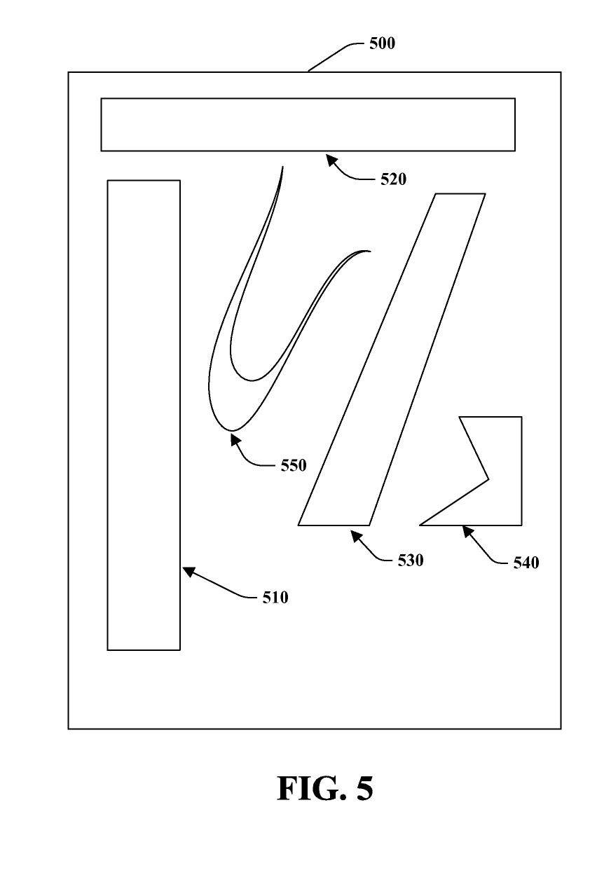

Referring to FIG. 5, illustrates example data selection groupings from a data set 500. In this aspect, it is noted that data groupings and selections are not limited to column and row groupings. As illustrated, dimensional displays and projections can indeed originate from column data shown at 510. Similarly, row data 520 can be selected for base presentations or as dimensional data to be used in subsequent projections. As can be appreciated, more exotic selections, collections, or aggregations of data can be achieved. A trapezoidal collection of data is show at 530 that selects data diagonally over column and row data. An angular structure groups or selects data at 540 and a U-shaped structure selects data at 550. As can be appreciated, other groupings are possible to be used for base renderings or as added projected dimensions. In some instances, mathematical equations may specify how data is defined in a particular grouping and ultimately selected.

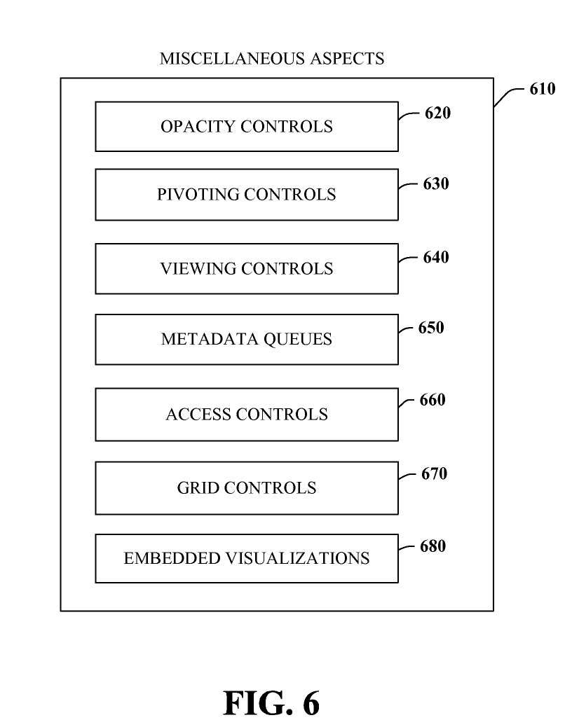

Referring to FIG. 6, miscellaneous visualization controls 610 are illustrated. At 620, opacity controls can be provided to facilitate rendering. Use of opacity can be applied as changes to visualization as an additional dimension. Also, color change or other animation can be provided. This includes animating certain items with filter changes while animating across time and then expanding into two-dimensions and observing how data flows. Then, expand to three or more dimensions. Use of animation does not have to be persistent and color can be associated with an item where the color could be changing through animation. At 630, pivoting controls can be provided. This includes techniques to manipulate and explore data. As it relates to spreadsheets, a user can perceive a two-dimensional slice and then pivot 90 degrees to see data that is contained in Column “A” in each spreadsheet, for example. Thus, common data points can be perceived in a visual manner.

At 640, viewing controls can be provided. This includes the use of cube displays to manipulate 3-D of data. Typically, all data is attached to original data as a collaboration or collection in one system. During presentations, allow users freedom to explore related data, however, may want to also focus on topic (e.g., contain the degree of exploration). Interactivity as feedback can be added to a presentation. Audience participation during renderings or animations can be encouraged via wireless network sharing of data.

At 650, data structures can be bound to a preferred visualization type via metadata. This provides semantic knowledge of data and allows populating annotations across chart or other data types. At 660, one or more access controls can be provided. This enables users to select various levels of data e.g., “Powers user” access to data, metadata, model, and key rules, for example. At 670, grid controls can be provided, where the grid is associated with the potential display of data. Thus, the grid itself could be provided as a component of interactive visualization. This can also enable drill downs or to see additional dimensions. For example, enabling visualizing multidimensional structures where a chart is a two-dimensional projection onto the screen.

At 680, projected visualizations or sequences can be embedded within other data structures or motifs. For example, embed a projected visualization within an advertisement. If the customer selects some aspect of the advertisement, project that selection as an additional dimension of data for the respective customer. Various dimensions could reflect underlying data of interest. e.g., price, availability, utility, use, and so forth. Advertising analytics can be applied to review advertisement campaigns and the effectiveness of the campaign. Includes click through rates and conversion rates. Provide paths that advertisers want users to follow to complete the action—track and model in a graphical form. Dimensional views can also be generated to coax feedback from user during advertisements.

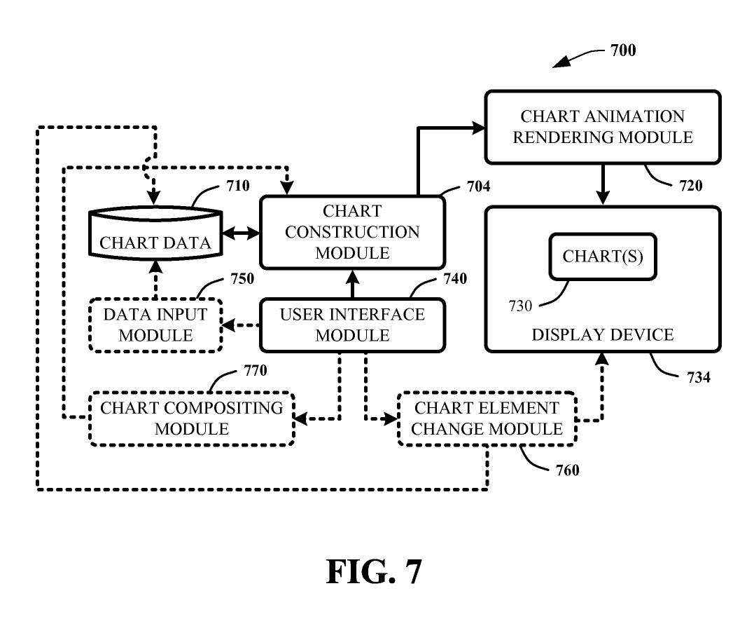

Referring to FIG. 7, an example system 700 is illustrated for transitioning or morphing between dynamic display visualizations. In general, a Charting Animator process generally begins operation by using a chart construction module 704 to define parameters used to construct one or more charts (e.g., Pie Charts, Bar Charts, Line Charts, Area Charts, Plateau Charts, etc.) using one or more sets of chart data 710. The chart construction module 704 then provides these parameters to a chart animation rendering module 720 which renders chart(s) 730 on a display device 734 (or surface).

When the chart(s) 730 have been rendered on the display device 704, changes to the rendered chart(s) are enabled using any of several aspects. For example, in one aspect, a user interface module 740 is utilized to modify one or more of data elements comprising the chart data 710 via a data input module 750. Modifications to these data elements include changing the value of one or more of the data elements, adding one or more data elements, and deleting one or more data elements. In general, these data elements are maintained in a conventional computer readable format, such as, for example, in a list, table, database, and so forth. Consequently, direct modifications to the data elements by using a user interface to change the data elements via the data input module 750 can be accomplished using conventional techniques.

When data elements have been modified, the chart construction module 704 determines new chart parameters corresponding to the modified data elements, and passes those chart parameters to the chart animation rendering module 720. At this point, the chart animation rendering module 720 then morphs the existing charts(s) 730 into new chart(s) 730 using a dynamic animation that smoothly transitions from the existing chart(s) to the new chart(s) on the display device 734.

In another aspect, changes to the rendered chart(s) 730 are enabled by directly modifying one or more elements of the chart(s), such as, for example, resizing the height of one or more bars on a Bar Chart, or changing the size of a pie slice in a Pie Chart. In various aspects, direct modification of the elements of the chart(s) is accomplished via the user interface module 740 which allows the user to select one or more individual elements of one or more charts 730 using a graphical user interface provided via a chart element change module 760. This graphical user interface provides a graphical interface to chart(s) 730 being rendered on the display device 734 for resizing, moving, sorting, or deleting one or more of those chart elements. Similarly, chart elements can also be added to one or more of the chart(s) 730 via the graphical user interface provided by the chart element change module 760.

When any chart elements have been modified (by resizing, moving, sorting, deleting, adding, etc.), the chart element change module 760 then automatically modifies the corresponding data elements of the chart data 710 (or adds new values to the chart data) to fit changes made to the chart elements. For example, if a bar in a Bar Chart originally had a value of “10,” then that bar was resized via the chart element change module 760 to show a value of “5” on the display device 734, then the chart element change module can change the value of the corresponding data element to “5” in the chart data 710.

Depending upon the chart(s) being displayed, many of the chart elements are often interdependent. Consequently, changes to one data element (either via the data input module 750, or via the chart element change module 760) used to construct the chart will often have an effect either on other data values, or on the displayed chart(s) 730. For example, if a pie slice in a Pie Chart is deleted or resized, or the underlying data value is changed, the other slices in the Pie Chart can be resized so that the Pie Chart retains a full pie shape. Therefore, when a change to data elements of the chart data 710 occurs (by any mechanism described herein), the chart construction module 704 determines new chart parameters corresponding to the modified data elements, and passes those chart parameters to the chart animation rendering module 720. At this point, the chart animation rendering module 720 then morphs the existing charts(s) 730 into new chart(s) 730 utilizing a dynamic animation that smoothly transitions from the existing chart(s) to the new chart(s) on the display device 734

In yet another aspect, a chart compositing module 770 is accessed via the user interface module 740 for creating a composite chart from two or more existing charts 730. In general, the user can use the chart compositing module 770 to specify (or select from a predefined list) some mathematical relationship between two or more existing charts 230. This mathematical relationship is then used to construct a composite chart by passing composite chart parameters to the chart construction module which in turn passes those parameters to the chart animation rendering module which acts to render the composite chart on the display device as an animation that morphs the existing charts into the composite chart.

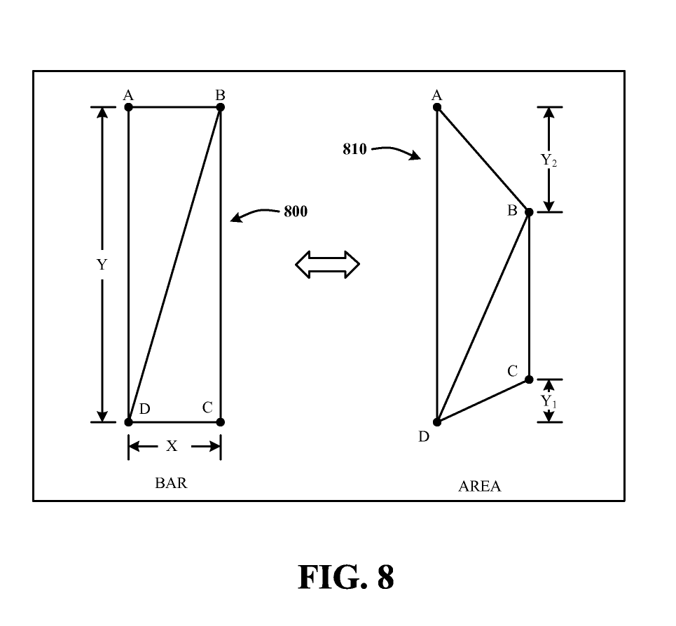

Referring to FIG. 8, an example visualization transition is illustrated. In general, the system 700 previously described has the ability to morph chart elements of one shape into chart elements of another shape, such as, for example, morphing to or from a rectangle to a line segment, area segment, or pie slice. This morphing is generally achieved by moving existing points of the various chart elements to create the new shapes, then rendering intermediate shapes to create the animated transition. Further, in addition to moving points to define a new shape, various animation components introduce new points as needed. For example, a pie slice employs many more points than a rectangular bar of a Bar Chart; so, when transitioning from a bar to a pie slice, more points are added—and when transitioning away from a pie slice, those extra points are removed.

Changing the shape of chart elements from one shape to another, such as, for example, changing a rectangular bar of a Bar Chart to a polygon of an Area Chart, or changing a rectangular bar of a Bar Chart to a pie slice of a Pie Chart is achieved by smoothly morphing the chart element from the original shape to the new shape to provide an animated transition between the shapes. This morphing can be accomplished using any of a number of morphing techniques.

For example, in one aspect, as illustrated by FIG. 8, a rectangular bar of a Bar Chart is morphed into a polygon of an Area Chart. Note that this example is not intended to limit the way in which shapes are morphed, and is provided only as a simple illustration of shape morphing techniques that may be utilized by the various animation techniques described or inferred herein.

A rectangle 800 defined by corner points {A, B, C, D} is changed to polygon 810 by translating point B by offset Y2, and translating point C by offset Y2. Clearly, any of the four points of rectangle 800 can be translated in either the X or Y direction to provide the desired shape. Similarly, translating some or all of the points, depending upon the shape, is used for scaling the shape. For example, translating two or more of points A, B and C towards (or away from) point D can be used to scale the size of rectangle 800 either up or down. Further, any one of the four points of rectangle 800 can be collapsed into another of those points to create a triangle from the rectangle 800. In any case, once the points of the new shape have been determined, the animation from the original shape to the new shape is created by simply rendering a sequence of intermediate images in steps as small as one pixel for each point, over some period of time. As can be appreciated, a plurality of various shapes, forms, and associated dimensions can be morphed or transitioned from one shape or form to another.

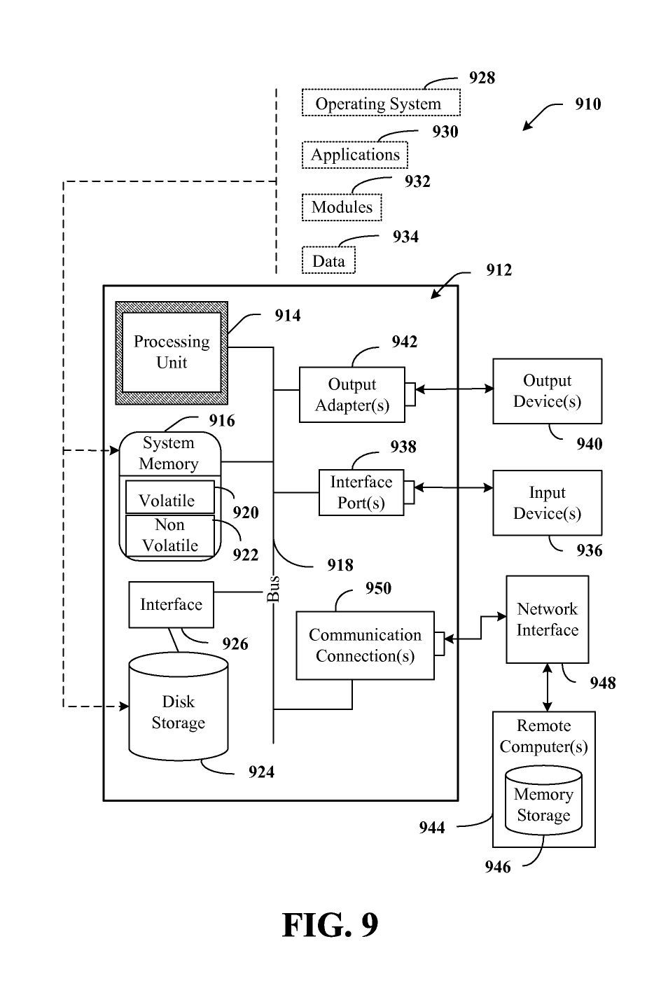

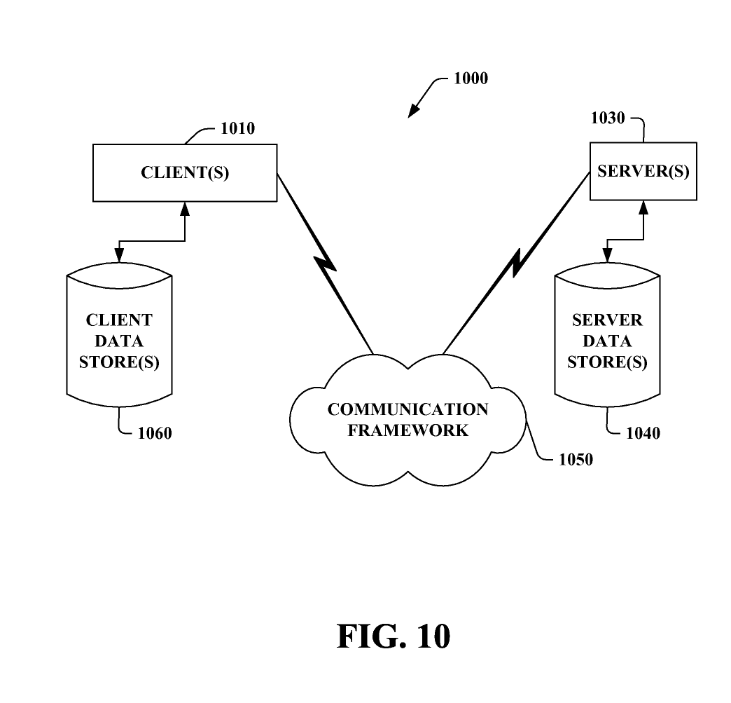

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that performs particular tasks and/or implements particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 9, an exemplary environment 910 for implementing various aspects described herein includes a computer 912. The computer 912 includes a processing unit 914, a system memory 916, and a system bus 918. The system bus 918 couple system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 64-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912 and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operably connected to one or more client data store(s) 1060 that can be employed to store information local to the client(s) 1010. Similarly, the server(s) 1030 are operably connected to one or more server data store(s) 1040 that can be employed to store information local to the servers 1030. It is noted that some of the computation may be performed on either side of a network, with a thin visualization being local. Similarly, mobile devices such as a cell phone can be applicable for visualizations since there is only so much screen size, and thus making a decision about what to show is relevant.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A visualization system, comprising:
a visualization component that displays at least two dimensions of data in at least a two dimensional view of the data;
a selection component to indicate at least one other dimension of data; and
a projection component that expands the two dimensional view of the data with at least one other dimensional view of the data.

2. The system of claim 1, further comprising a speed control to adjust the rate of animation presented to the user.

3. The system of claim 2, the rate is adjusted based off of capabilities of the user.

4. The system of claim 3, the rate is adjusted in view of data or viewing complexity.

5. The system of claim 1, the two dimensions of data are projected on to a surface having height and width, the at least one other dimension adds depth to the surface.

6. The system of claim 1, further comprising bidirectional controls for selection, where one direction allows data sets to be identified and projected on to existing data sets and a second direction selects portions of a displayed image where different components of data are highlighted or made less prominent.

7. The system of claim 6, further comprising a sequencing control to adjust how data sets are projected on to an existing data set.

8. The system of claim 7, further comprising a historical component that can decompose previous animation sequences.

9. The system of claim 1, further comprising a component to deconstruct a complex image into smaller element portions.

10. The system of claim 1, further comprising a component to illustrate transitions or trends.

11. The system of claim 1, further comprising a component to present variable suggestions to a user.

12. The system of claim 1, further comprising a component to change the rate at which animations are presented, where some movements are rapidly rendered and other movements are slowed to facilitate the user's ability to focus on to a new scene or rendering.

13. The system of claim 1, further comprising a component to extrude a lower dimensional view from a higher dimensional view.

14. The system of claim 13, if the lower dimensional view is selected, the component highlights the lower dimensional view and removes the higher dimensional views from a given display.

15. The system of claim 1, further comprising one or more alternative controls to facilitate rendering of a display, the controls include opacity controls, viewing controls, pivoting controls, access controls, and grid controls.

16. A visualization animation method, comprising:
analyzing a set of data for rendering information relating to a visualization;
generating an initial rendering of the visualization;
determining an alternative data set for the visualization; and
projecting the alternative data set on to the initial rendering of the visualization, the alternative data set employed to expand the dimensionality of the initial rendering.

17. The method of claim 16, further comprising employing one or more controls to adjust a rate for presentation of the visualization.

18. The method of claim 17, further comprising sequencing an animation series of renderings to highlight a data set.

19. The method of claim 16, further comprising providing to controls that suggest alternative rendering or data analysis formats.

20. A visualization system, comprising:
means for generating a two dimensional display of data from a plurality of data sets;
means for selecting a data set or gesturing to the display of data; and
means for projecting an additional dimension of data on to the display of data, the additional dimension of data selected from the plurality of data sets.
